(19) United States
(12) Patent Application Publication
(10) Pub. No.: US 2005/0278229 A1
(43) Pub. Date: Dec. 15, 2005

(54) System for order and fulfillment of occupational prescription eyewear

(76) Inventor: Gilbert Igo, Brownsburg, IN (US)

Correspondence Address: CANTOR COLBURN, LLP, 55 GRIFFIN ROAD SOUTH, BLOOMFIELD, CT, 06002, US

(21) Appl. No.: 11/003,813

(22) Filed: Dec. 2, 2004

Related U.S. Application Data
(60) Provisional application No. 60/526,706, filed on Dec. 2, 2003.

(51) Int. Cl. G06F 17/60

(52) U.S. Cl. 705/26

(57) ABSTRACT

A web-based system for order and fulfillment of occupational prescription eyewear is provided, including providing user account initiation interface; providing an interface prompting user selection of eyewear components; providing a prescription form to the user; and fulfillment of an eyewear order based on user selection of eyewear components and the prescription from such professional and based on receipt of a completed prescription form from a professional qualified to make such prescription.

### CROSS-REFERENCE TO RELATED APPLICATIONS

The present application claims priority to U.S. Provisional Patent Application Ser. No. 60/526,706, the entire contents of which are specifically incorporated herein in its entirety.

### BACKGROUND

The present disclosure describes a system for user placement and manufacturer fulfillment of occupational prescription eyewear.

### SUMMARY

In an exemplary embodiment, the presently described system includes user account initiation, user selection of eyewear components, provision of a prescription form to the user, receipt of the completed prescription form from a professional qualified to make such prescription, and fulfillment of an eyewear order based on user selection of eyewear components and the prescription from such professional.

The above-discussed and other features and advantages of the improved temple piece for eyewear will be appreciated and understood by those skilled in the art from the following detailed description and drawings.

### BRIEF DESCRIPTION OF THE DRAWINGS

Referring now to the drawings, wherein like elements are numbered alike in the several FIGURES:

FIG. 1 illustrates a flowchart of an exemplary registration process;

FIG. 2 illustrates an exemplary “Welcome” page;

FIG. 3 illustrates an exemplary “Program Description” page

FIG. 4 illustrates an exemplary page describing compliance standards;

FIG. 5 illustrates an exemplary registration page;

FIG. 6 illustrates an exemplary registration/order form;

FIG. 7 illustrates an exemplary options popup; and

FIG. 8 is a flowchart of an exemplary order process.

### DETAILED DESCRIPTION OF EXEMPLARY EMBODIMENTS

Reference will now be made in detail to exemplary embodiments, examples of which are illustrated in the accompanying drawings.

The presently described system and web program advantageously provides means for profitably servicing small existing clients and gaining and servicing new clients likely to buy in lower than bulk levels. Such may be achieved by provision of a facile and useful web based interface for the user, streamlined processes relating to all aspects of the transaction, and automated payment options.

The presently described system and web program also may benefit from various promotions, including telemarketing, direct mailing, fax marketing, email marketing and/or search engine placement.

The presently described system and web program may also be configured to provide information on compliance standards, workman's compensation, productivity information, cost comparisons, program options and descriptions, questions and answers, registration information, information about the manufacturer and dispenser network, and frames catalogs.

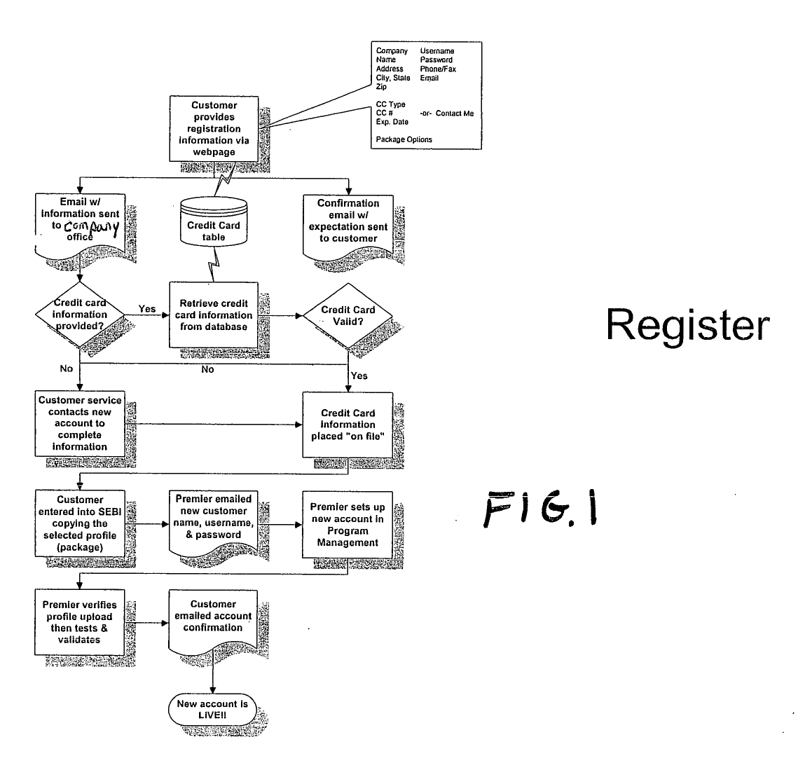

FIG. 1 illustrates a flowchart of an exemplary registration process. Such exemplary process includes communication with a user via electronic mail confirming entry of registrant data, processing of credit card information, creation of an account by the company's customer service, provision of account and password information to the user and activation of the account.

With further reference to FIG. 1, in an initial exemplary setting, a web page may invite a user to provide or fill in registration information, such as company name, individual name, address, credit card information (or an option to request telephone or other separate contact for such credit card information, and possible package options. Submission of such information may prompt the system to send out a communication to the individual or the individual's company with confirmation of information receipt. Where a credit card is provided, credit card information may also be verified and filed (where accurate), or a notice may be sent to the company or the individual where such credit verification fails.

Following verification of payment information, the system may generate and test or validate an account for the customer, including registration information, user name and password. The system may assign user name and password information to the customer account, or the system may accept user names and/or passwords entered by the customer for the customer's account. Following account setup, the system may also send a communication to the customer indicating successful account setup.

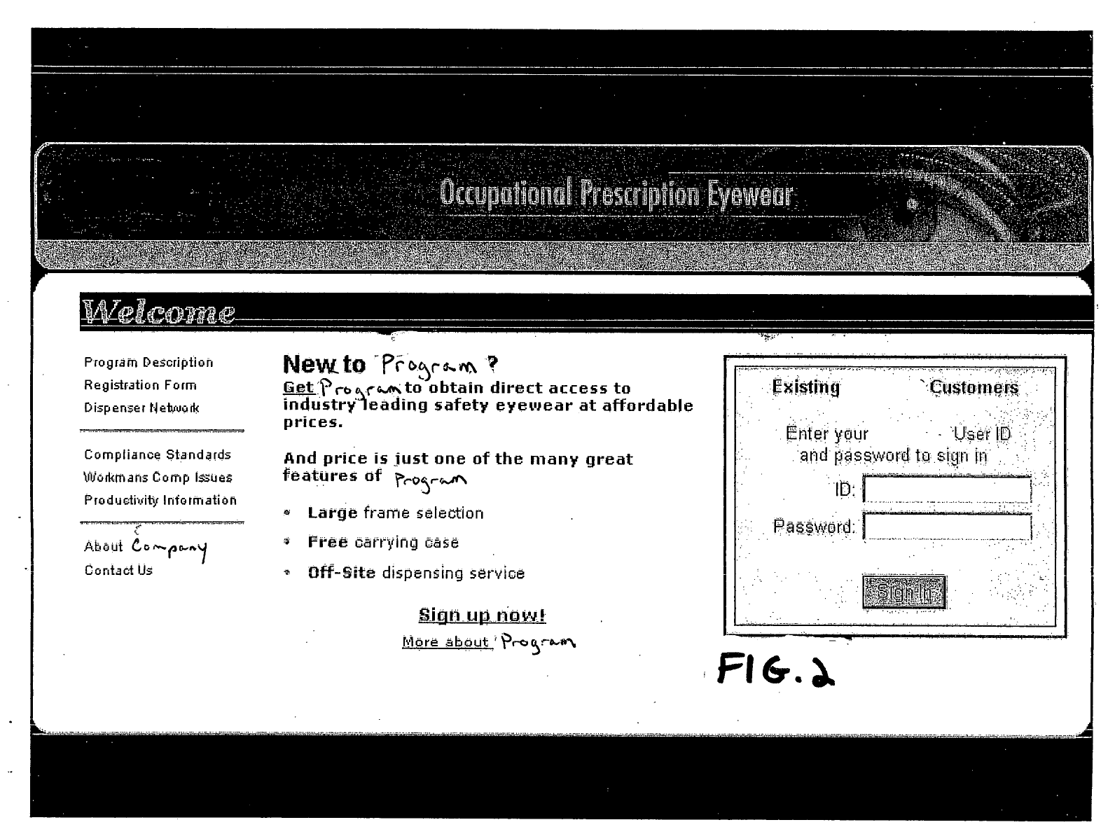

FIG. 2 illustrates an exemplary “Welcome” page, providing logon for existing customers, promotional information, program links, and program signup opportunities. Customers with active accounts may log onto the system by simply providing user name and password information, while new users may link to a sign-up page, which may contain features as described above with regard to FIG. 1.

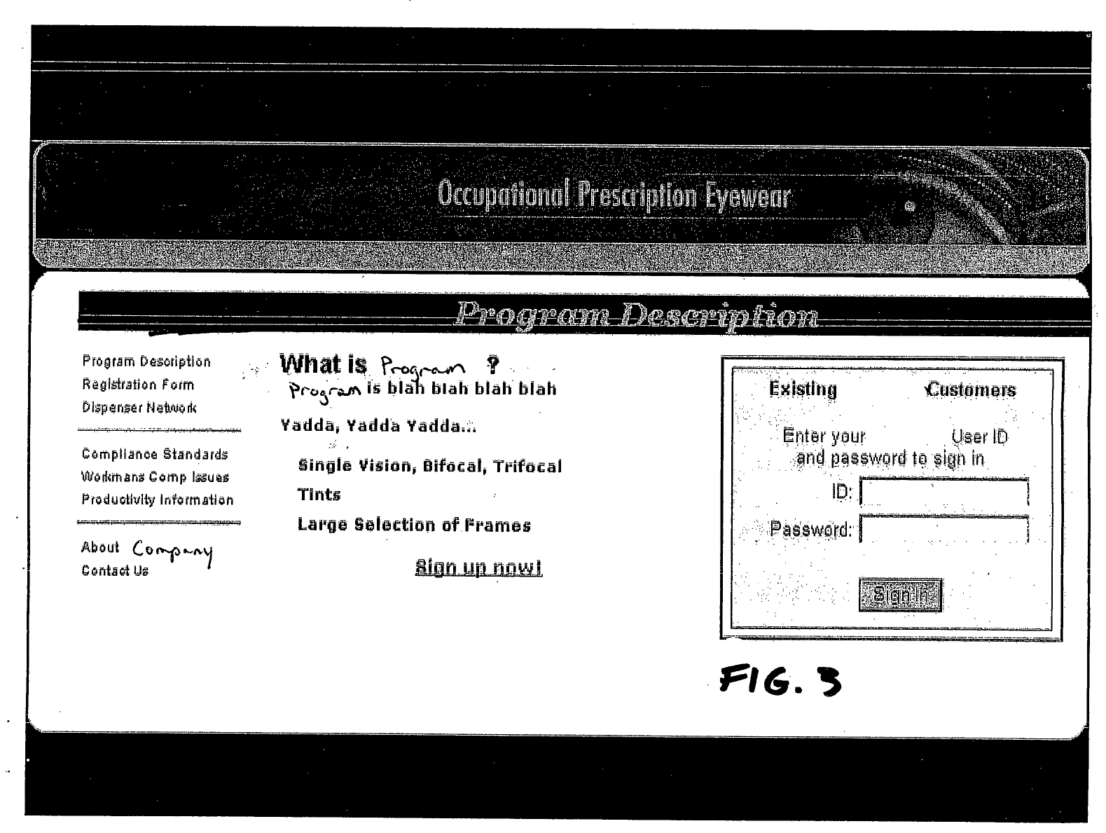

FIG. 3 illustrates an exemplary “Program Description” page, which may describe, prior to log-on or registration for a new account, various aspects of the program and occupational prescription eyewear components that are obtainable via the program (for example, single vision lenses, bifocal lenses, trifocal lenses, various tints, and various frames). As with the exemplary embodiment of FIG. 2, the page may also include various links to promotional, news or industry information (such as compliance standards).

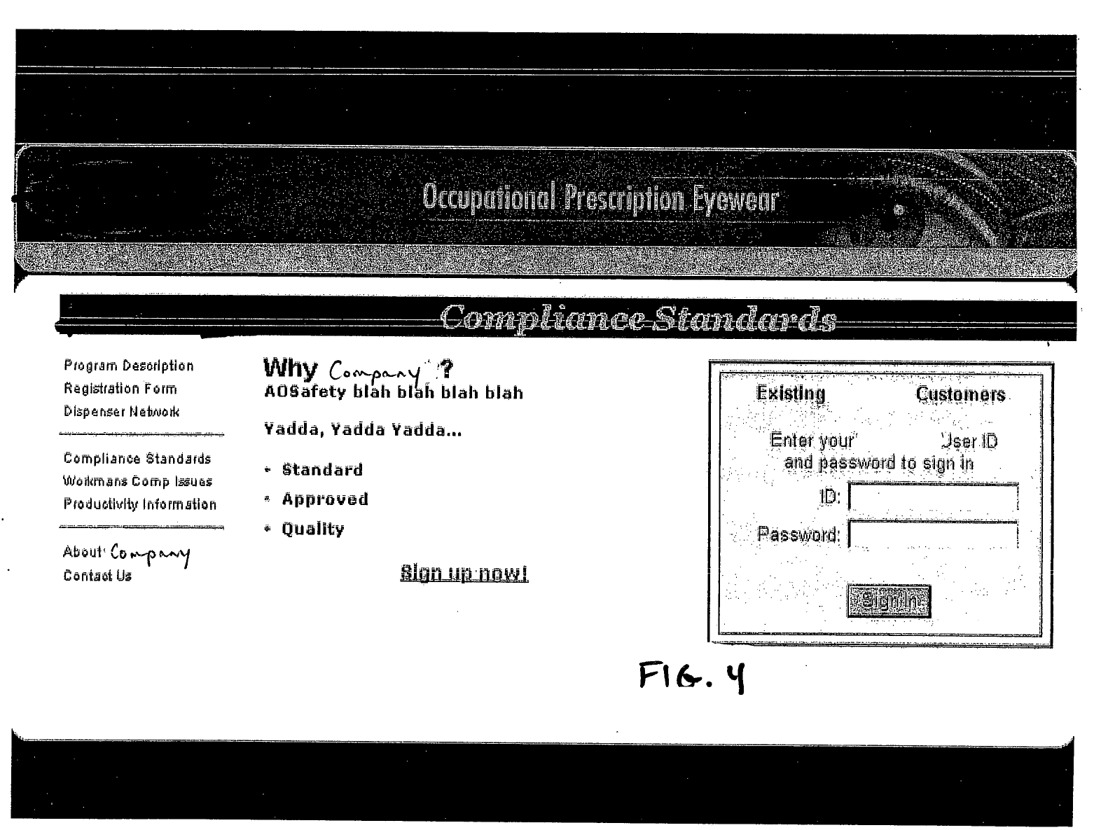

FIG. 4 illustrates an exemplary page describing compliance standards. An opportunity to either log-on to an existing account or to set up a new account may also be provided, along with various other links to additional promotional, news or industry information.

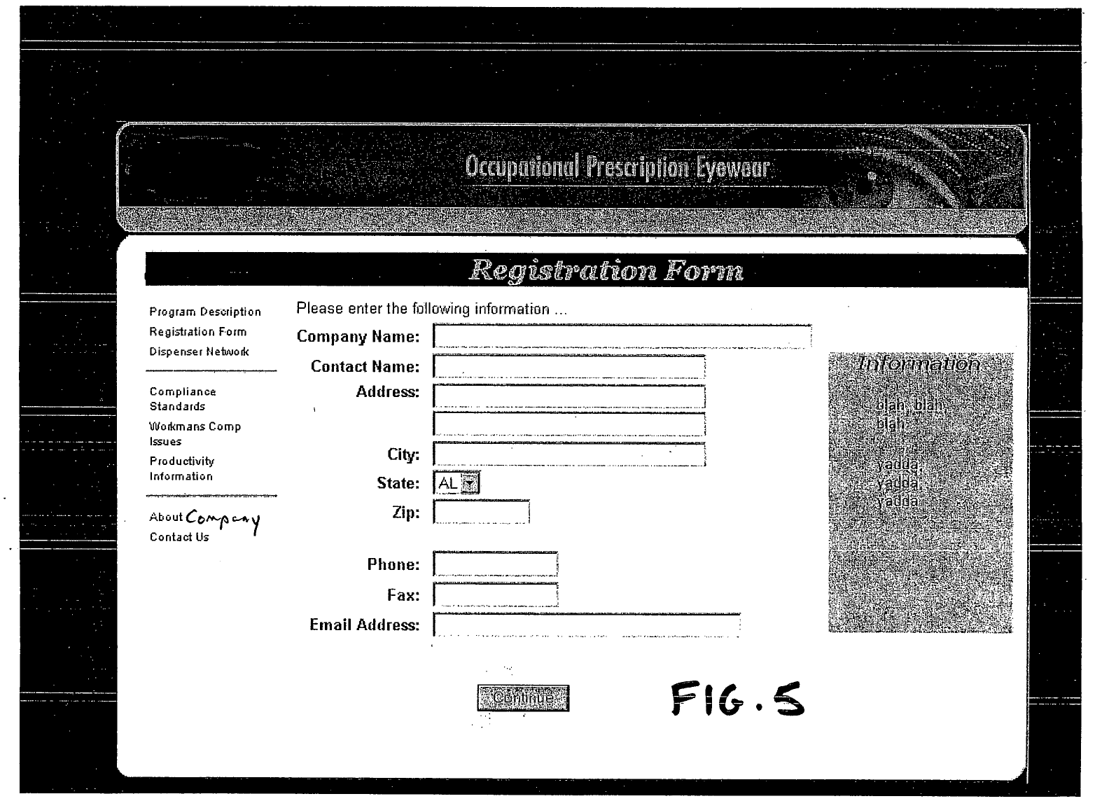

FIG. 5 illustrates an exemplary registration page or form, permitting entry of various of the registration information described above with regard to FIG. 1, such as company name, contact name, address, telephone information, email addresses.

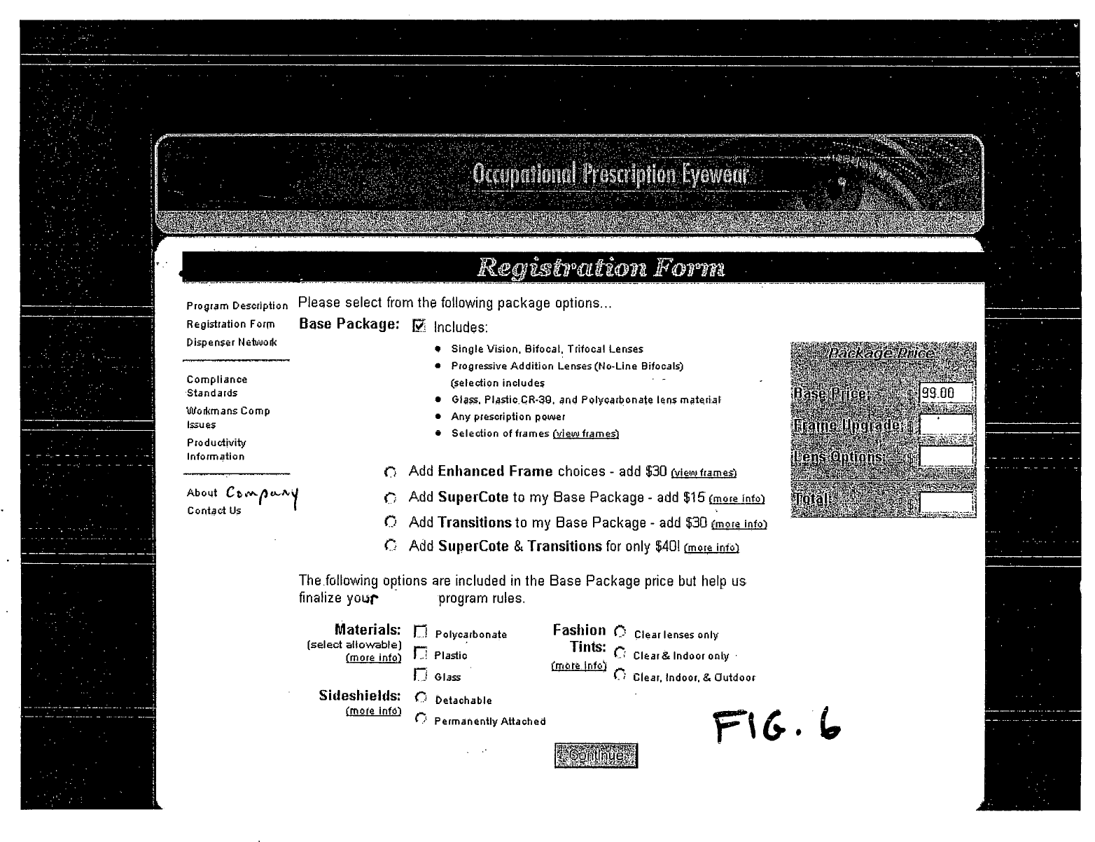

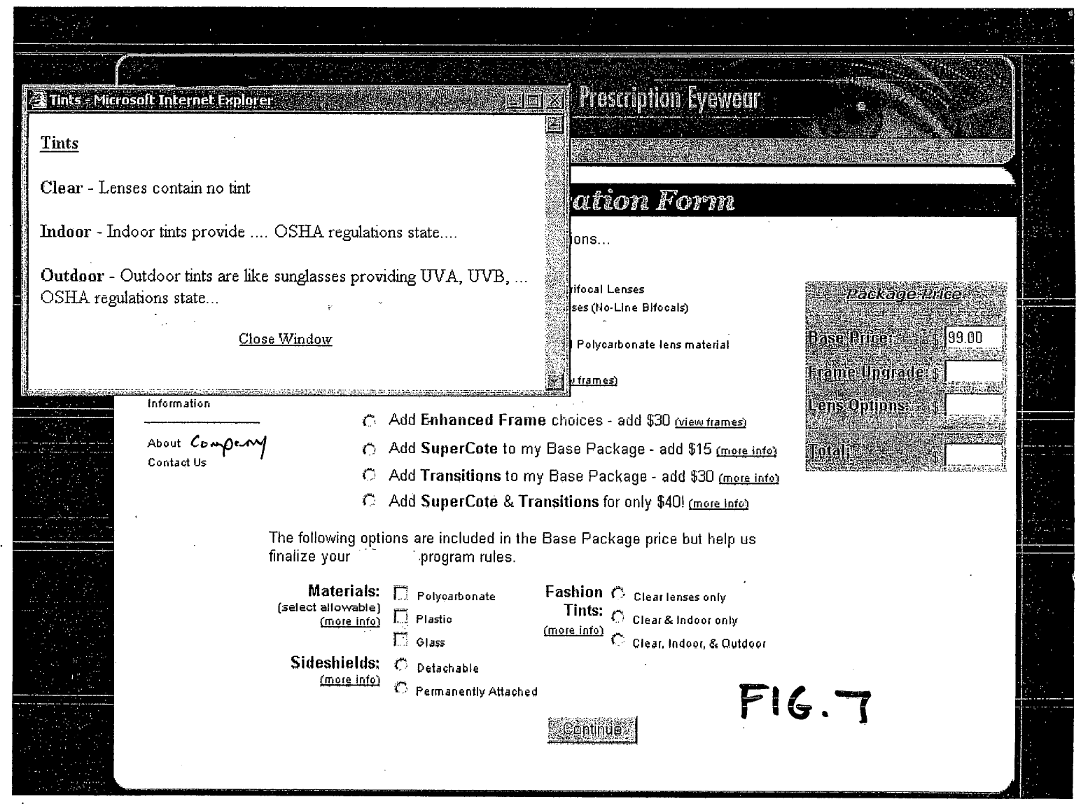

FIG. 6 illustrates an exemplary registration/order form, describing various packages and options and including links for more information with regard to the options (see, for example the options popup with regard to tints in FIG. 7). In the illustrated embodiment of FIG. 6, the registration form describes (and provides the user the opportunity to select) a base package, including the option of single, bifocal or trifocal lenses, progressive addition lenses, glass, plastic, cr-39 or polycarbonate lens material, with any prescription power, option of side shields and with a base selection of frames. As the user selects the base package, a package price field updates to show a base price of $99, for example. Additional options are also selectable, including various frame and lens upgrades. Various other links to additional promotional, news or industry information may also be provided.

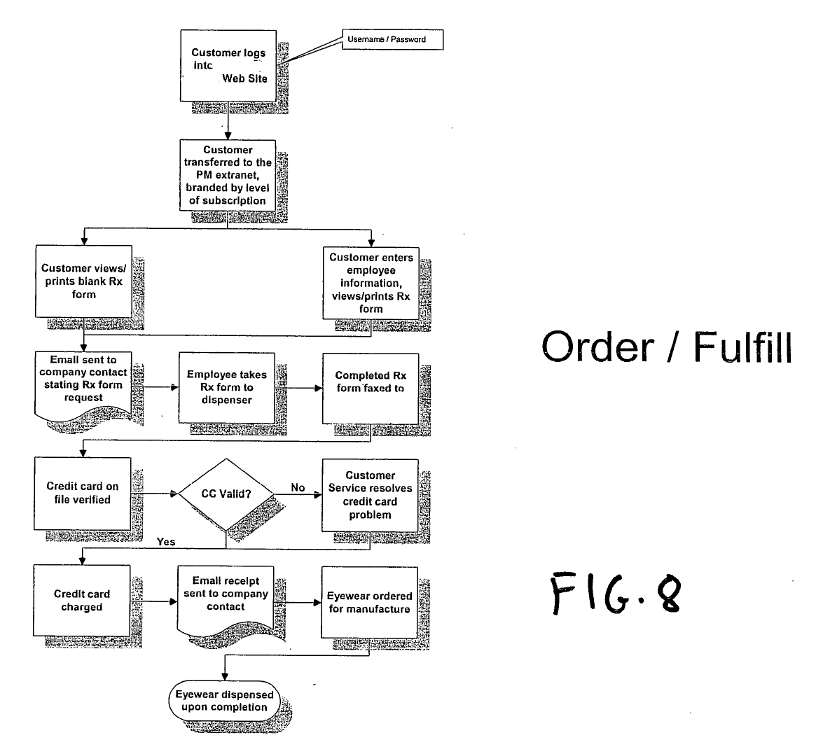

FIG. 8 is a flowchart of an exemplary order process, process for providing a prescription form to a user, process for receiving a completed order form and process for billing the user and dispensing the product. Subsequent to log on by an active customer, the customer may automatically be directed to an interface appropriate for the customer's level of subscription. Such customer may be provided with a blank prescription form and/or provided an opportunity to customize entries on a prescription form (e.g., for name, company name, address, etc.) and/or a pre-customized prescription form may be provided. A correspondence (e.g., email) may be sent out to the individual or company requesting such prescription fill. A completed prescription may then be provided to the system or company operating the system, and subsequent to verification of billing, eyewear may be ordered for manufacture according to the customer selections and the prescription content.

It will be apparent to those skilled in the art that, while exemplary embodiments have been shown and described, various modifications and variations can be made to the present system and web interface disclosed herein without departing from the spirit or scope of the invention. For example, the new account setup process may be modified as desired. Additionally, user accounts may be modifiable (e.g., password management, profile management, credit card information revisable). Usage reporting may be incorporated. Credit card validation may be adjusted as desired, and information may be stored in various program management databases. Accordingly, it is to be understood that the various embodiments have been described by way of illustration and not limitation.

1. A web-based system for order and fulfillment of occupational prescription eyewear, comprising:
providing user account initiation interface;
providing an interface prompting user selection of eyewear components;
providing a prescription form to the user; and
fulfillment of an eyewear order based on user selection of eyewear components and the prescription from such professional and based on receipt of a completed prescription form from a professional qualified to make such prescription.

2. The web-based system in accordance with claim 1, wherein said user account interface provides said interface prompting user selection of eyewear components.

3. The web-based system in accordance with claim 1, wherein said user account interface permits entry of personal or corporate information, as well as billing information and/or user name and password requests.

4. The web-based system in accordance with claim 1, wherein said interface prompting user selection of eyewear components includes a base package selection, as well as at least one additional eyewear option.

5. The web-based system in accordance with claim 4, wherein said eyewear option includes one or more of selection of single, bifocal or trifocal lenses, selection of progressive addition lenses, selection of glass, plastic, cr-39 or polycarbonate lens material, selection of any prescription power, selection of side shields, selection of frames, and selection of lens tint.

6. The web-based system in accordance with claim 4, wherein said base package comprises one or more of the following included in base package price: selection of single, bifocal or trifocal lenses, selection of progressive addition lenses, selection of glass, plastic, cr-39 or polycarbonate lens material, selection of any prescription power, selection of side shields, selection of frames, and selection of lens tint.

7. The web-based system in accordance with claim 1, wherein said interface prompting user selection of eyewear components includes an indicator of the price of said selected eyewear components.

8. The web-based system in accordance with claim 4, wherein said interface prompting user selection of eyewear components includes an indicator of the price of said selected eyewear components.

9. The web-based system in accordance with claim 1, wherein said interface prompting user selection of eyewear components includes at least one link directing to, or at least one informative popup relative to an eyewear feature.

10. The web-based system in accordance with claim 1, wherein said provided prescription is provided as a custom form based on user account information.

11. The web-based system in accordance with claim 1, wherein said provided prescription is provided as customizable to the user prior to printing.

12. The web-based system in accordance with claim 1, wherein fulfillment of an eyewear order is prompted by receipt of a completed prescription form.

13. The web-based system in accordance with claim 1, wherein fulfillment of an eyewear order is prompted by download of a completed prescription form.

14. The web-based system in accordance with claim 1, wherein fulfillment of an eyewear order is prompted by facsimile receipt of a completed prescription form.

15. The web-based system in accordance with claim 13, wherein fulfillment of an eyewear order is not effected until verification of billing is obtained by the system.

16. The web-based system in accordance with claim 14, wherein fulfillment of an eyewear order is not effected until verification of billing is obtained by the system.

17. The web-based system in accordance with claim 1, wherein account registration request, account setup and/or fulfillment of an eyewear order is confirmed by system communication with the user.

18. The web-based system in accordance with claim 17, wherein account registration request, account setup and/or fulfillment of an eyewear order is confirmed by confirmation email to the user.

19. The web-based system in accordance with claim 1, further comprising one or both of a welcome page and a program description page, the page permitting user log-on for active user accounts and/or user sign-up for new user accounts and/or providing program, promotional, news or industry information or links to program, promotional, news or industry information.
